(19) United States
(12) Patent Application Publication
(10) Pub. No.: US 2017/0139693 A1
(43) Pub. Date: May 18, 2017

(54) CODE EXECUTION METHOD AND DEVICE

(71) Applicant: Shanghai Muji Network Technology Co., Ltd., Shanghai (CN)

(72) Inventor: Shuang Li, Shanghai (CN)

(21) Appl. No.: 15/049,463

(22) Filed: Feb. 22, 2016

(30) Foreign Application Priority Data
Nov. 18, 2015 (CN) 201510797067.7

(51) Int. Cl. G06F 9/45

(52) U.S. Cl. CPC G06F 8/443

(57) ABSTRACT

Code execution method and device are provided. The method includes: converting a source code into an intermediate code which supports interpretive execution and compiled execution, where the compiled execution does not support a blocking operation; interpretively executing the intermediate code; dynamically profiling the intermediate code during the interpretive execution to obtain a profiling result; and if the profiling result meets a requirement of starting the compiled execution, switching to perform the compiled execution to the intermediate code. The method and the device may improve code execution efficiency.

### CROSS-REFERENCE TO RELATED APPLICATIONS

The present application claims priority to Chinese patent application No. 201510797067.7, filed on Nov. 18, 2015, and entitled “CODE EXECUTION METHOD AND DEVICE”, and the entire disclosure of which is incorporated herein by reference.

### FIELD OF THE DISCLOSURE

The present disclosure generally relates to computer field, and more particularly, to a code execution method and device.

### BACKGROUND OF THE DISCLOSURE

Computer technology has been developed rapidly and is widely used in various fields. Code execution is one basis of the computer technology. Codes are executed to achieve expected object and effect.

Code execution can be classified into two types including asynchronous single-threaded execution and multi-threaded execution, or classified into a blocking operation mode and a non-blocking operation mode. In the blocking operation mode, a particular process or program is suspended to, for example, wait for a signal, wait for a file being prepared, or wait for a network data packet being received completely. After the waiting, the particular process or program is continued to be executed. In the non-blocking operation mode, if the signal or a file is not prepared, or a network data packet is not received completely, the particular process or program doesn't wait for these operations, that is to say, a current thread is not blocked.

Existing techniques do not have advantages of both the two operation modes, and execution efficiency needs to be improved.

### SUMMARY

in embodiments of the present disclosure, code execution efficiency may be improved.

In an embodiment of the present disclosure, a code execution method is provided, including: converting a source code into an intermediate code which supports interpretive execution and compiled execution, where the compiled execution does not support a blocking operation; interpretively executing the intermediate code; dynamically profiling the intermediate code during the interpretive execution to obtain a first profiling result; and if the first profiling result meets a requirement of starting the compiled execution, switching to perform the compiled execution to the intermediate code.

Optionally, the method may further include: dynamically profiling the intermediate code during the compiled execution to obtain a second profiling result; and if the second profiling result meets a requirement of starting the interpretive execution, switching to perform the interpretive execution to the intermediate code.

Optionally, the requirement of starting the compiled execution may include: a code segment whose invocation frequency is higher than a frequency threshold being present in the intermediate code.

Optionally, the requirement of starting the interpretive execution may include: a blocking operation being present in the intermediate code.

Optionally, the method may be adapted to be executed in a browser, the interpretive execution performed to the intermediate code may include interpretively executing the intermediate code using an interpreter which is written in a script language that can be directly run by the browser, and the compiled execution performed to the intermediate code may include compiling the intermediate code into a code in a script language that can be directly run by the browser.

Optionally, the script language that can be directly run by the browser may include JavaScript language, and the compiled execution performed to the intermediate code may further include: after the intermediate code is compiled into the code in the JavaScript language, a JavaScript engine executing the code in the JavaScript language.

Optionally, the intermediate code may be a virtual machine instruction code.

In an embodiment of the present disclosure, a code execution device is provided, including a code conversion unit, an interpretive execution unit, a first switching unit and a compiled execution unit, wherein the code conversion unit is configured to convert a source code into an intermediate code which supports interpretive execution and compiled execution, where the compiled execution does not support a blocking operation; the interpretive execution unit is configured to interpretively execute the intermediate code; and the first switching unit is configured to: dynamically profile the intermediate code during the interpretive execution to obtain a first profiling result; and if the first profiling result meets a requirement of starting the compiled execution, switch to the compiled execution unit to perform the compiled execution to the intermediate code.

Optionally, the device may further include a second switching unit, configured to: dynamically profile the intermediate code during the compiled execution to obtain a second profiling result; and if the second profiling result meets a requirement of starting the interpretive execution, switch to the interpretive execution unit to perform the interpretive execution to the intermediate code.

Optionally, the requirement of starting the compiled execution may include a code segment whose invocation frequency is higher than a frequency threshold being present in the intermediate code.

Optionally, the requirement of starting the interpretive execution may include a blocking operation being present in the intermediate code.

Optionally, the code execution device may be adapted for a browser, the interpretive execution unit may be configured to interpretively execute the intermediate code using an interpreter which is written in a script language that can be directly run by the browser, and the compiled execution unit may be configured to compile the intermediate code into a code in a script language that can be directly run by the browser.

Optionally, the script language that can be directly run by the browser may include JavaScript language, and the compiled execution unit is further configured to: compile the intermediate code into the code in the JavaScript language which is to be executed by a JavaScript engine.

Optionally, the intermediate code may be a virtual machine instruction code.

Optionally, the code execution device may be adapted for a browser.

Embodiments of the present disclosure may have following advantages. A source code is converted into an intermediate code which supports both interpretive execution and compiled execution, the intermediate code is interpretively executed, the intermediate code is dynamically profiled during the interpretive execution to obtain a profiling result, and if the profiling result meets a requirement of starting the compiled execution, the compiled execution is performed to the intermediate code. Therefore, based on the dynamic profiling to the intermediate code, a more suitable and efficient execution mode may be selected for the intermediate code, so that code execution efficiency may be improved.

### BRIEF DESCRIPTION OF THE DRAWINGS

FIG. 1 schematically illustrates a flow chart of a code execution method according to an embodiment of the disclosure; and

FIG. 2 schematically illustrates a structural diagram of a code execution device according to an embodiment of the disclosure.

### DETAILED DESCRIPTION OF THE DISCLOSURE

As described in the background, code execution can be classified into two types including asynchronous single-threaded execution and multi-threaded execution, or classified into a blocking operation mode and a non-blocking operation mode. Either the blocking operation mode or the non-blocking operation mode has advantages and disadvantages. However, in the existing techniques, multiple languages only support one of the two operation modes, which results in relatively low execution efficiency.

In embodiments of present disclosure, a source code is converted into an intermediate code which supports both interpretive execution and compiled execution, the intermediate code is interpretively executed, the intermediate code is dynamically profiled during the interpretive execution to obtain a profiling result, and if the profiling result meets a requirement of starting the compiled execution, the compiled execution is performed to the intermediate code. Therefore, based on the dynamic profiling to the intermediate code, a more suitable and efficient execution mode may be selected for the intermediate code, so that code execution efficiency may be improved.

In order to clarify the objects, characteristics and advantages of the disclosure, embodiments of present disclosure will be described in detail in conjunction with accompanying drawings.

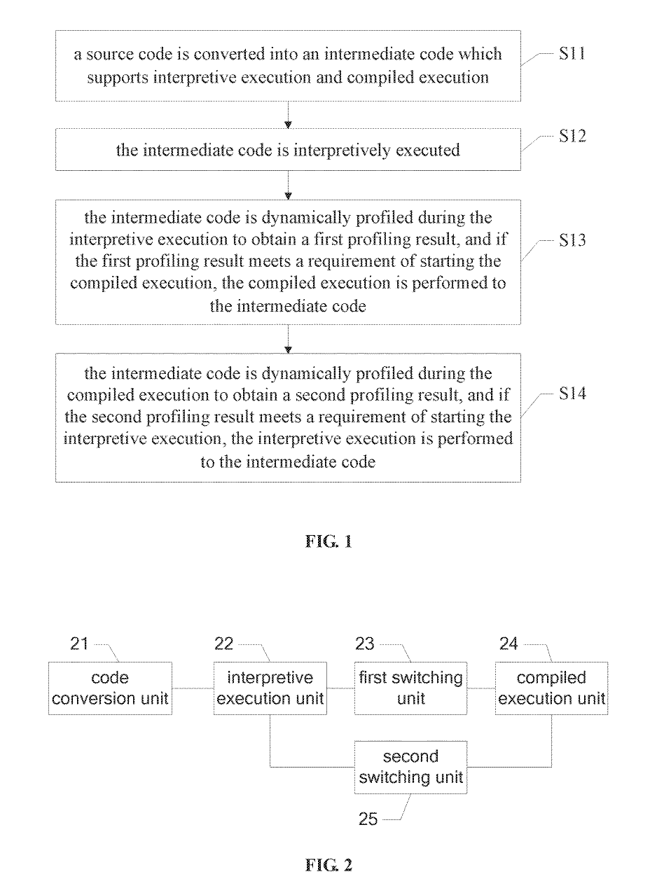

FIG. 1 schematically illustrates a flow chart of a code execution method according to an embodiment of the disclosure. Referring to FIG. 1, the method includes S11 to S14.

In S11, a source code is converted into an intermediate code which supports interpretive execution and compiled execution, where the compiled execution does not support a blocking operation.

In some embodiments, the source code may be written in a particular programming language, such as C language, C++ language or Objective-C language. In some embodiments, the source code may be written in a particular language which supports a blocking operation.

In some embodiments, the intermediate code may support both interpretive execution and compiled execution, and may be a code of virtual machine instructions.

Interpretive execution may be performed by using an interpreter to execute the intermediate code. Although execution efficiency of the interpretive execution is lower than that of the complied execution, the interpretive execution has some advantages. For example, a code footprint is relatively small, and it takes relatively short time to start codes. Besides, the interpretive execution can support blocking operations, so that collaborative multi-threading are further supported. The interpretive execution is adapted for codes which are invoked less frequently, such as initialization codes or logic codes invoked less frequently.

A language for writing the interpreter may depend on and should accommodate practical application environment where the codes are executed.

In S12, the intermediate code is interpretively executed.

As described above, interpretive execution includes using an interpreter to execute the intermediate code, supports blocking operations, and further supports collaborative multi-threading. A language for writing the interpreter depends on and should accommodate practical application environment where the codes are executed.

In S13, the intermediate code is dynamically profiled during the interpretive execution to obtain a first profiling result, and if the first profiling result meets a requirement of starting the compiled execution, the compiled execution is performed to the intermediate code.

In some embodiments, the intermediate code may be dynamically profiled periodically. The requirement of starting the compiled execution may be set based on characteristics of the compiled execution.

The compiled execution may include: converting the intermediate code into a target code, and using an engine which is adapted for the target code to execute the target code. In some embodiments, in the compiled execution, the intermediate code may be converted into the target code by a Just-In-Time (JIT) compiler. The target code may be determined based on practical application environment where codes are executed, and should be adapted to be directly executed in the practical application environment.

As the compiled execution can compile a source code into a target code which is adapted for application environment, execution efficiency of the compiled execution may be much higher than that of the interpretive execution. However, a generated code footprint is relatively large, and it takes relatively long time to start the codes. Besides, a code including a blocking operation may not be able to run in the compiled execution.

The compiled execution may be adapted for codes which are invoked more frequently, such as a core loop used frequently or a compute-intensive algorithm. Therefore, during the interpretive execution, the profiling to the intermediate code and the setting of the requirement of starting the compiled execution may depend on invocation frequency.

In some embodiments, the requirement of starting the compiled execution may include a code segment whose invocation frequency is higher than a frequency threshold being present in the intermediate code. The invocation of the code segment may be a function invocation. In some embodiments, the interpreter may calculate invocation frequency of each function. When the invocation frequency is higher than the frequency threshold, it is determined that the requirement of starting the compiled execution is met.

In some embodiments, the code execution method may further include S14.

In S14, the intermediate code is dynamically profiled during the compiled execution to obtain a second profiling result, and if the second profiling result meets a requirement of starting the interpretive execution, the interpretive execution is performed to the intermediate code.

In some embodiments, the intermediate code may be dynamically profiled periodically. The requirement of starting the interpretive execution may be set based on characteristics of the interpretive execution.

As described above, interpretive execution may be performed by using an interpreter to execute the intermediate code. Although execution efficiency of the interpretive execution is lower than that of the complied execution, the interpretive execution still has some advantages. For example, a code footprint is relatively small, and thus it takes relatively short time to start codes. Besides, the interpretive execution can support blocking operations, so that collaborative multi-threading are further supported. The interpretive execution is adapted for codes which are invoked less frequently, such as initialization codes or logic codes invoked less frequently.

In some embodiments, the requirement of starting the interpretive execution may be set based on characteristics of the interpretive execution. In some embodiments, the requirement of starting the interpretive execution may be a blocking operation being present in the intermediate code.

Transition from the compiled execution to the interpretive execution requires an On-Stack Replacement (OSR). That is, although functions used in the compiled execution do not return a value (namely, still in an on-stack state), the functions are switched into interpretive execution.

In some embodiments, the code execution method may be adapted to be executed in a browser. The interpretive execution performed to the intermediate code may include: interpretively executing the intermediate code using an interpreter which is written in a script language that can be directly run by the browser. The compiled execution performed to the intermediate code may include: compiling the intermediate code into a code in a script language that can be directly run by the browser.

In some embodiments, the interpretive execution performed to the intermediate code may include: interpretively executing the intermediate code using an interpreter which is written in JavaScript language. In some embodiments, the compiled execution performed to the intermediate code may include: after the intermediate code is compiled into the code in the JavaScript language, using a JavaScript engine to execute the code in the JavaScript language.

The JavaScript language is one type of script languages and the only programming language which is supported by a standard Internet browser. Therefore, a mass of codes which are written in other programming languages, such as C language, C++ language or Objective-C language, can not be run directly in a browser.

In existing techniques, C or C++ codes are compiled into JavaScript, such as asm.js, to be run in a browser. However, the techniques are limited to an asynchronous single-threaded execution model of JavaScript, and do not support C or C++ codes which use a synchronous blocking programming model. Thus, an application range of the techniques is limited. Besides, JavaScript generated by compiling is too large, which leads to a longer startup time and increases the possibility of a browser crash.

In embodiments of the present disclosure, a non-JavaScript code is converted into an intermediate code which can be executed by interpretive execution and compiled execution.

When blocking occurs during the execution, a current context and an invocation stack need to be safely saved prior to returning to a main message loop to process other messages (or returning to a thread scheduler to switch to other threads). In this manner, the context and the invocation stack can be restored effectively when a blocked thread is waked up. In the interpretive execution, a running state and an invocation stack of a thread are simulated in an interpreter, so that they can be saved and restored. While codes are compiled into JavaScript, the running state and the invocation stack of the thread is managed by a JavaScript engine of a browser, which is out of direct control of application codes. Thus, a blocking operation cannot be performed.

In embodiments of the present disclosure, a source code is converted into an intermediate code which supports both interpretive execution and compiled execution, the intermediate code is interpretively executed, the intermediate code is dynamically profiled during the interpretive execution to obtain a profiling result, and if the profiling result meets a requirement of starting the compiled execution, the compiled execution is performed to the intermediate code. Therefore, based on the dynamic profiling to the intermediate code, a more suitable and efficient execution mode may be selected for the intermediate code, so that code execution efficiency may be improved.

Referring to FIG. 2, a code execution device is provided according to an embodiment of the disclosure. The code execution device includes a code conversion unit 21, an interpretive execution unit 22, a first switching unit 23 and a compiled execution unit 24.

The code conversion unit 21 may be configured to convert a source code into an intermediate code which supports interpretive execution and compiled execution, where the compiled execution does not support a blocking operation.

The interpretive execution unit 22 may be configured to interpretively execute the intermediate code.

The first switching unit 23 may be configured to: dynamically profile the intermediate code during the interpretive execution to obtain a first profiling result; and if the first profiling result meets a requirement of starting the compiled execution, switch to the compiled execution unit 24 to perform the compiled execution to the intermediate code.

In some embodiments, the code execution device may further include a second switching unit 25, configured to: dynamically profile the intermediate code during the compiled execution to obtain a second profiling result; and if the second profiling result meets a requirement of starting the interpretive execution, switch to the interpretive execution unit 22 to perform the interpretive execution to the intermediate code.

In some embodiments, the requirement of starting the compiled execution may include a code segment whose invocation frequency is higher than a frequency threshold being present in the intermediate code.

In some embodiments, the requirement of starting the interpretive execution may include a blocking operation being present in the intermediate code.

In some embodiments, the code execution device may be adapted for a browser. The interpretive execution unit 22 may be configured to interpretively execute the intermediate code using an interpreter which is written in a script language that can be directly run by the browser. The compiled execution unit 24 may be configured to compile the intermediate code into a code in a script language that can be directly run by the browser.

In some embodiments, the interpretive execution unite 22 may be configured to interpretively execute the intermediate code using an interpreter which is written in JavaScript language. In some embodiments, the compiled execution unit 24 may be configured to compile the intermediate code into the code in the JavaScript language which is to be executed by a JavaScript engine.

In some embodiments, the intermediate code may be a virtual machine instruction code.

Those skilled in the art can understand all the steps or part of the steps in the methods in above embodiments can be implemented using related hardware that is instructed by programs. The programs may be stored in a computer readable memory medium, such as a Read Only Memory (ROM), a Random Access Memory (RAM), a magnetic disk or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A code execution method, comprising:
converting a source code into an intermediate code which supports interpretive execution and compiled execution, where the compiled execution does not support a blocking operation;
interpretively executing the intermediate code;
dynamically profiling the intermediate code during the interpretive execution to obtain a first profiling result; and
if the first profiling result meets a requirement of starting the compiled execution, switching to perform the compiled execution to the intermediate code.

2. The method according to claim 1, further comprising:
dynamically profiling the intermediate code during the compiled execution to obtain a second profiling result; and
if the second profiling result meets a requirement of starting the interpretive execution, switching to perform the interpretive execution to the intermediate code.

3. The method according to claim 2, wherein the requirement of starting the interpretive execution comprises a blocking operation being present in the intermediate code.

4. The method according to claim 1, wherein the requirement of starting the compiled execution comprises a code segment whose invocation frequency is higher than a frequency threshold being present in the intermediate code.

5. The method according to claim 1, wherein the method is adapted to be executed in a browser, the interpretive execution performed to the intermediate code comprises interpretively executing the intermediate code using an interpreter which is written in a script language that can be directly run by the browser, and the compiled execution performed to the intermediate code comprises compiling the intermediate code into a code in a script language that can be run by the browser.

6. The method according to claim 5, wherein the script language that can be directly run by the browser comprises JavaScript language, and the compiled execution performed to the intermediate code further comprises: after the intermediate code is compiled into the code in the JavaScript language, a JavaScript engine executing the code in the JavaScript language.

7. The method according to claim 1, wherein the intermediate code is a virtual machine instruction code.

8. A code execution device, comprising a code conversion unit, an interpretive execution unit, a first switching unit and a compiled execution unit,
wherein the code conversion unit is configured to convert a source code into an intermediate code which supports interpretive execution and compiled execution, where the compiled execution does not support a blocking operation;
the interpretive execution unit is configured to interpretively execute the intermediate code; and
the first switching unit is configured to: dynamically profile the intermediate code during the interpretive execution to obtain a first profiling result; and if the first profiling result meets a requirement of starting the compiled execution, switch to the compiled execution unit to perform the compiled execution to the intermediate code.

9. The device according to claim 8, further comprising a second switching unit, configured to: dynamically profile the intermediate code during the compiled execution to obtain a second profiling result; and if the second profiling result meets a requirement of starting the interpretive execution, switch to the interpretive execution unit to perform the interpretive execution to the intermediate code.

10. The device according to claim 9, wherein the requirement of starting the interpretive execution comprises a blocking operation being present in the intermediate code.

11. The device according to claim 8, wherein the requirement of starting the compiled execution comprises a code segment whose invocation frequency is higher than a frequency threshold being present in the intermediate code.

12. The device according to claim 8, wherein the code execution device is adapted for a browser, the interpretive execution unit is configured to interpretively execute the intermediate code using an interpreter which is written in a script language that can be directly run by the browser, and the compiled execution unit is configured to compile the intermediate code into a code in a script language that can be directly run by the browser.

13. The device according to claim 12, wherein the script language that can be directly run by the browser comprises JavaScript language, and the compiled execution unit is further configured to: compile the intermediate code into the code in the JavaScript language which is to be executed by a JavaScript engine.

14. The device according to claim 8, wherein the intermediate code is a virtual machine instruction code.
